(19) United States
(12) Patent Application Publication
(10) Pub. No.: US 2010/0319446 A1
(43) Pub. Date: Dec. 23, 2010

(54) Method of Indicating the Degree of Ageing Experienced by a Tire

(76) Inventor: Jean Coue, Romagnat (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/446,450

(22) PCT Filed: Oct. 9, 2007
(86) PCT No.: PCT/EP07/60717

§ 371 Date: Apr. 20, 2009

(30) Foreign Application Priority Data
Oct. 20, 2006 (FR) 0609344

(51) Int. Cl. B60C 23/20; G01K 1/14

(52) U.S. Cl. 73/146; 374/141; 374/E01.018

(57) ABSTRACT

A method of indicating the degree of ageing experienced by a tire as it is being driven on by a vehicle. The temperature is measured locally at least one point of the tire, the time of exposure to the temperature is measured and these measurements are analyzed using a model of the tire.

The invention relates to a method of indicating the degree of ageing experienced by a tire as it is being driven on by a vehicle. The invention also relates to the use of at least one local temperature measurement at one point of the tire and of the measurement of the time of exposure to the said temperature to determine an indication of the degree of ageing experienced by the said tire as it is being driven on by a vehicle.

Although not limited to this type of application, the invention will be described more specifically with reference to tires fitted to vehicles of the heavy goods vehicle type, such as lorries, buses, tractors, trailers, etc. The cost of tires for vehicles such as lorries represents a not-insignificant proportion of the cost of transporting goods. It is therefore always desirable to optimize tire efficiency.

One first route might be to optimize the use made of these tires with a view in particular to improving their life. Another route, that complements the previous one, is to ensure that there is at least the possibility of retreading the tire when its tread has worn down.

A tire such as this usually consists of a carcass reinforcement anchored on each side in the bead region, radially surmounted by a crown reinforcement consisting of at least two superposed layers formed of threads or cables that are parallel within each layer. It may also comprise a layer of not very extensile metal cables or threads that form an angle of between 45° and 90° with the circumferential direction, this ply, known as the cross-bracing, being located radially between the carcass reinforcement and the first crown layer known as the working layer, each of which is formed of parallel threads or cables at angles of 45° at most in terms of absolute value.

The working layers are formed of inextensible metal reinforcing elements that are mutually parallel within each layer and are crossed from one layer to the next, making angles of between 10° and 45° with the circumferential direction. The said working layers, that form the working reinforcement, may also be covered with at least one layer known as a protective layer made up of advantageously metallic and extensile reinforcing elements known as elastic reinforcing elements.

Some present-day tires, known as “road tires”, are intended to run at high speed over increasingly lengthy journeys, because of improvements in the road, transport network and the growth of the motorway network worldwide. There is no doubt that all of the conditions under which a tire such as this has to be driven on allow an increase in the number of kilometers covered because tire wear is lower, but this is at the expense of the endurance of the tire and, in particular, of the crown reinforcement.

This is because there are stresses in the crown reinforcement and, more specifically, shear stresses between the crown layers, combined with a not-insignificant increase in the operating temperature at the ends of the axially shortest crown layer, which cause cracks to appear and spread in the rubber compound at the said ends. This problem exists in the case of edges of two layers of reinforcing elements, the said layers not necessarily having to be radially adjacent.

When, for example, there is a desire to retread the tire after the tread has worn down, it is necessary for the tire to be retreaded before the ageing becomes too pronounced, so as to optimize the use that can be made of the new tread.

In order to improve the endurance of the crown reinforcement of the type of tire being studied, solutions relating to the structure and to the quality of the layers and/or profiles of rubber compounds arranged between and/or around the ends of the plies and more particularly the ends of the axially shortest ply have already been applied.

Patent FR 1 389 428, in order to improve the resistance to degradation of the rubber compounds situated near the crown reinforcement edges recommends the use, in conjunction with a low-hysteresis tread, of a rubber profile that covers at least the sides and the marginal edges of the crown reinforcement and constitutes a low-hysteresis rubber compound.

Patent FR 2 222 232, in order to avoid separation between crown reinforcement plies, teaches that the ends of the reinforcement can be coated in a mat of rubber, the Shore A hardness of which differs from that of the tread surmounting the said reinforcement and is greater than the Shore A hardness of the profile of rubber compound arranged between the edges of the crown reinforcement and carcass reinforcement plies.

French application FR 2 728 510 proposes that, on the one hand, an axially continuous ply formed of inextensible metal cables making an angle of at least 60° with the circumferential direction and the axial width of which is at least equal to the axial width of the shortest working crown ply be arranged between the carcass reinforcement and the crown reinforcement working ply radially closest to the axis of rotation and that, on the other hand, an additional ply formed of metallic elements directed substantially parallel to the circumferential direction be arranged between the two working crown plies.

French application WO 99/24269 further proposes that the two working crown plies formed of reinforcing elements that cross from one ply to the next be coupled over a certain axial distance on either side of the equatorial plane and in the immediate axial extension of the additional ply of reinforcing elements substantially parallel to the circumferential direction, so that these can subsequently be decoupled by profiles of a rubber compound at least over the remainder of the width common to the said two working plies.

It has nonetheless been found that, depending on the conditions in which the tires are used, whatever steps are taken, driving over long distances may result in the tire experiencing an advanced degree of ageing.

The circumferential direction of the tire, or longitudinal direction, is the direction corresponding to the periphery of the tire and defined by the direction of travel of the tire.

The transverse or axial direction of the tire is parallel to the axis of rotation of the tire.

The radial direction is a direction that intersects the axis of rotation of the tire and is perpendicular thereto.

The axis of rotation of the tire is the axis about which it rotates in normal use.

A radial or meridian plane is a plane containing the axis of rotation of the tire.

The circumferential mid-plane, or equatorial plane, is a plane perpendicular to the axis of rotation of the tire and which splits the tire into two halves.

It is also known practice to employ electronic modules in tires for various types of application that involve acquiring, storing and/or transmitting information regarding the tire.

Such electronic modules may comprise passive components such as identity chips or RFIDs, and/or active components connected to a self-contained electrical power supply system such as batteries or, alternatively, an inductive coupling system. These electronic modules may be designed to exchange information with external modules, used for example as user interfaces, via radio waves the frequency and power of which are carefully tuned and in accordance with specific transmission protocols. They may also be designed to store information so that they can be interrogated at a later date.

It is known practice, particularly from document EP 1 275 949, to implant a wireless sensor in tires in order to determine the forces or stresses applied within the tire.

Document EP 0 937 615 for its part describes the use of surface acoustic wave wireless sensors incorporated into a tire in order in particular to measure tire grip. A sensor such as this has the advantage that it can be interrogated remotely, via radio waves, wirelessly, without a nearby source of energy being required. The energy of the interrogating radio wave transmitted by a remote interrogation device is high enough for the sensor to send out a modified radio wave in reply.

Electronic modules such as surface acoustic wave (SAW) wireless sensors or bulk acoustic wave (BAW) sensors may also be used in tires to measure physical parameters. One important advantage is that they can be interrogated remotely by radio wave without requiring a nearby source of power.

Electronic modules can therefore be fitted inside the cavity formed by the tire once it has been mounted on the wheel or alternatively may be implanted within the rubber compound of the tire.

The inventors therefore set themselves the task of being able to estimate the degree of ageing experienced by a tire, for example, in order to decide whether or not it can be retreaded.

This object was achieved according to the invention using a method of indicating the degree of ageing experienced by a tire as it is being driven on by a vehicle, whereby the temperature is measured locally at least one point of the tire, the time of exposure to the said temperature is measured, these measurements being analyzed using a model of the said tire.

Within the meaning of the invention, analysis using a model of the tire entails, for example, applying the measurements to the said model in order to determine their consequences.

According to a preferred embodiment of the invention, the model of the said tire is a system of graphs and/or a numerical model.

Within the meaning of the invention, a model of the tire means a representation of the ageing experienced by the tire as a function of temperature parameters at a point on the tire and as a function of time of exposure to the said temperature. This type of model, which is within the competence of a person skilled in the art, may be obtained empirically and/or by numerical simulation.

The inventors have been able to demonstrate that, independently of the distance traveled by the tire, the temperature of the said tire at a point on the tire and the times of exposure to these temperatures during driving are the determining factors in the degree of ageing experienced by the tire. The use of models specific to the said tire will thus make it possible, from each measurement, to estimate the degree of ageing caused by the driving that has contributed to these temperature conditions.

The invention therefore requires a preliminary step which is that of creating this model of the tire, in theory for a given tire for a given size, or even for a set of tires with technically similar dimensions and characteristics.

The results obtained are of course only estimates of the degree of ageing because, while it is possible to assign a value representative of the degree of ageing experienced by a tire for a given use, it is not possible, with the knowledge available today, to relate this value to a tire life which remains unknown; such life is dependent on numerous parameters such as the conditions in which the tire is being used, as well as being dependent on the actual design of the tire.

One advantageous alternative form of the invention anticipates measuring the temperature at the ends of the working plies of the tire. As already stated, the temperature of the rubber compound in these regions of the tire is of particular relevance in terms of tire ageing.

The tire temperature measurements are then advantageously taken directly in these regions by using electronic modules such as those mentioned hereinabove.

According to a first embodiment of the invention, the measurements are recorded and it is the amassed set of measurements that is analyzed. According to this embodiment of the invention, the electronic module inserted inside the tire will be able to record the temperature measurements and times of exposure to these temperatures throughout the journeys made by the tire fitted to a vehicle.

These records will allow an analysis to be performed at a given moment using a model of the said tire and will allow the ageing caused by the journeys made to be estimated. For example, following tread wear, the retreading technician will take a decision as to whether the tire can be retreaded. This decision will be taken against a maximum degree of ageing that cannot be exceeded. This maximum level that cannot be exceeded is defined empirically by the technician for a given tire, for example using other tire testing means, particularly destructive testing.

According to another embodiment of the invention, the measurements are analyzed instantly and information is transmitted to the driver of the vehicle. According to this second embodiment of the invention, analysis of the measurements is performed continuously and information is transmitted to the driver. This information may in particular be transcribed into the form of information or advice aimed at altering the driving style in order to subject the vehicle tires to a lower degree of ageing.

The driver of the vehicle may thus adapt his style of driving to suit the conditions and thus minimize the degree of ageing experienced by the tires.

The invention also anticipates a combination of these two embodiments, it being possible for continuous information to be imparted to the driver while at the same time being stored in a buffer memory that can be interrogated at a later date, particularly when a decision as to whether the tire can be retreaded needs to be taken.

One advantageous embodiment of the invention anticipates that at least one temperature sensor, associated with recording and/or communicating means, be inserted into the tire and preferably near the axial ends of the working plies of the tire. An embodiment such as this may be carried out in accordance with the techniques already mentioned and allows access to precise measurements of temperatures and exposure times, there being no delay or dissipation to be taken into consideration as would be the case of a value obtained by extrapolating a measurement taken from a distance.

However, in an alternative form of embodiment, the invention anticipates taking the measurements using a remotely sited sensor which may, for example, be positioned in the cavity of the tire. Such measurements are then not as precise and are subject to delays, but are advantageous from an economical point of view because they are less expensive, particularly in terms of manufacture, and particularly when it is an amassed set of measurements that is going to be analyzed.

The invention also proposes the use of at least one local temperature measurement at one point of a tire and of the measurement of the time of exposure to the said temperature in order to determine an indication of the degree of ageing experienced by the said tire as it is being driven on by a vehicle, by analyzing these measurements using a model of the tire.

According to a first embodiment of the invention, this use of at least one local temperature measurement at one point of the tire and of the measurement of the time of exposure to the said temperature makes it possible to determine the suitability of a tire for retreading.

According to a second embodiment of the invention, this use of at least one local temperature measurement at one point of the tire and of the measurement of the time of exposure to the said temperature makes it possible to provide the driver of the vehicle with information as to the driving style to be adopted.

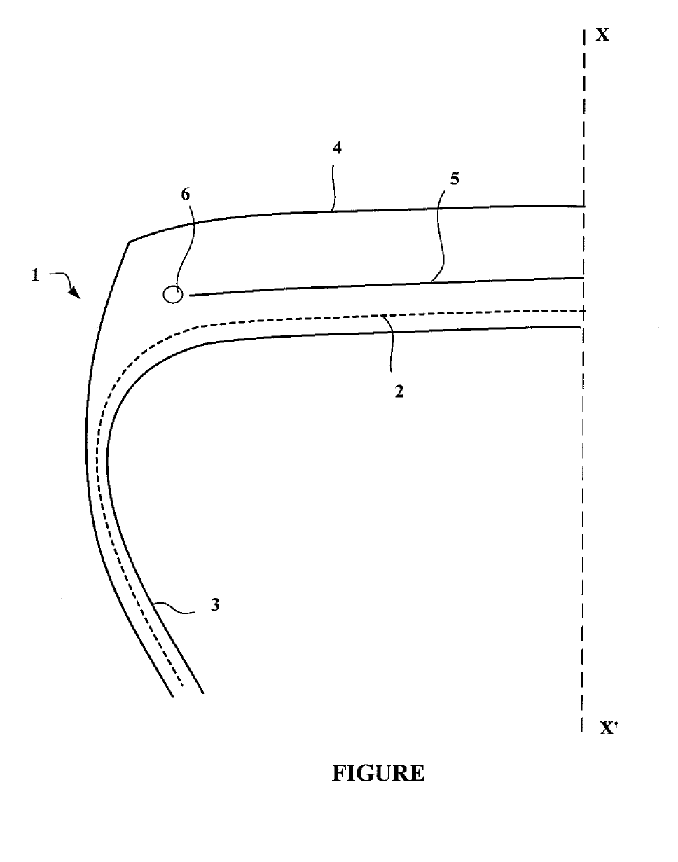

Further details and advantageous features of the invention will emerge hereinafter from the description of some embodiments of the invention which is given with reference to FIG. 1 which depicts a schematic meridian view of a tire.

In order to make the FIGURE easier to understand, it has not been drawn to scale.

FIG. 1 depicts just a partial view of half a tire 1 which extends symmetrically to the axis XX′ which represents the circumferential mid-plane, or equatorial plane, of the tire. In particular, the bottom regions and beads of the tire 1 have not been depicted in this FIGURE.

FIG. 1 depicts a tire 1 intended to be used on a vehicle of the heavy goods vehicle type comprising a carcass reinforcement made up of a single layer 2 comprising radially directed metallic reinforcing elements.

The said carcass layer 2 is anchored on each side of the tire 1 in a bead the base of which is intended to be mounted on a rim seat. Each bead is extended radially outwards by a sidewall 3, the said side wall 3 meeting the tread 4 radially towards the outside.

The tire 1 further comprises a crown reinforcement 5, details of which have not been depicted in the FIGURE. The crown reinforcement may comprise two layers of reinforcing elements that are mutually parallel and make acute angles with the circumferential direction, the said reinforcing elements being crossed from one layer to the next.

According to the invention, the tire comprises a temperature measurement system 6. This measurement system 6 is a wireless temperature sensor of the SAW (Surface Acoustic Wave) resonator type. This type of sensor has the advantage, as already explained, of requiring no associated power supply; it provides information about the temperature of the mass of rubber compound surrounding it by modifying a wave which it receives and re-transmits.

The tire may comprise a second sensor identical to the first and positioned symmetrically with respect to the axis XX′.

An interrogation device is advantageously provided on the vehicle to communicate with the sensor. The said interrogation device can then analyze the signal by associating it with the time of exposure to a measured temperature and making reference to a model of the tire and can then transmit the information to the driver. The interrogation device may alternatively be associated with a recording device such that it is the amassed set of temperatures and corresponding exposure times that is subsequently analyzed.

According to other alternative forms of embodiment of the invention, the temperature measurement sensor may be associated with one or more other electronic modules within the tire, these other modules having the ability to define the times of exposure to the various temperatures and to store this information. An embodiment such as this in particular allows this information to be interrogated at a later date for analysis on the basis of a model of the tire in question in order, for example, to determine from this information whether this tire can be retreaded.

This analysis of the amassed set of temperatures and corresponding exposure times is advantageous in particular in deciding on whether a tire can be retreaded, as explained previously.

The model of the tire is defined from tests or simulations performed beforehand; these tests or simulations consist, for example, in defining degrees of ageing experienced by the tire as a function of the measured temperatures and of the times of exposure to the said temperatures.

Tests have been carried out on several identical 315/70R22.5 tires mounted on rolling road test machines.

A sensor of the thermocouple type was inserted into each of the tires at the axial end of the working layers. The measurements were taken during a period of running corresponding to distances varying from 10 000 to 240 000 kilometers in a straight line for several tires.

The driving conditions used (variation in speed for example) caused different heating in the tires.

After these initial runnings, other tests, always identical for all the tires, were performed. The tires were then skewed at an angle of 5°. These last running tests, which were far more severe, made it possible to measure the distances covered by the tires before they deteriorated and thus classify the tires and define which of them could have been retreaded after the initial running tests.

Furthermore, after the initial running tests, analyses in accordance with the invention and performed on the basis of the measurements of temperature and of times of exposure to the said temperatures were performed in order to define which tires could be retreaded.

The analysis of the measurements taken according to the invention on the basis of the amassed set of temperatures and times of exposure to the said temperatures using the same pre-defined model led to different conclusions as to whether the said tires could be retreaded, depending on the distances covered and the variations in temperature experienced by the tires during the initial running tests.

The second running tests, which involved running the tires until they became damaged, confirmed the analyses performed according to the invention; specifically, the conclusions as to whether it would be possible to retread some of the tires after the first running tests were confirmed by the distances covered by the said tires, during the second tests, which were deemed to be satisfactory enough that the tires could have been retreaded. Likewise, the second tests confirmed the decisions that some tires could not have been retreaded as the distances covered by the said tires were deemed to be insufficient.

These tests, which were performed a number of times varying the driving parameters, confirm that the method of indicating the degree of ageing experienced by a tire according to the invention is able to provide a good indication as to whether a tire can be retreaded. This method according to the invention is particularly highly advantageous on account of the speed of analysis. There is, nonetheless, a subjective part associated with determining a maximum permissible degree of ageing, which requires the know-how of the retreading expert.

By contrast, making information regarding the instantaneous degree of ageing experienced by the tires continuously available to the driver in the form of advice as to the driving style to be adopted in order to limit this ageing does not require any additional know-how.

The results obtained during the tests also confirmed that the distance covered by the tires has no direct influence on the ageing experienced by these tires.

1. A method of indicating the degree of ageing experienced by a tire as it is being driven on by a vehicle, wherein the temperature is measured locally at least one point of the tire, wherein the time of exposure to the said temperature is measured and wherein these measurements are analyzed using a model of the said tire.

2. The method of indicating the degree of ageing experienced by a tire as it is being driven on according to claim 1, wherein the model is a system of graphs and/or a numerical model.

3. The method of indicating the degree of ageing experienced by a tire as it is being driven on according to claim 1, wherein the temperature is measured at the ends of the working plies of the tire.

4. The method of indicating the degree of ageing experienced by a tire as it is being driven on according to claim 1, wherein the measurements are recorded and wherein the degree of aging is the amassed set of measurements that is analyzed.

5. The method of indicating the degree of ageing experienced by a tire as it is being driven on according to claim 1, wherein the measurements are analyzed instantly and wherein information is transmitted to the driver of the vehicle.

6. The method of indicating the degree of ageing experienced by a tire as it is being driven on according to claim 1, wherein at least one temperature sensor, associated with recording and/or communication means, is inserted into the tire.

7-9. (canceled)
